(19) United States
(12) Patent Application Publication
(10) Pub. No.: US 2019/0033740 A1
(43) Pub. Date: Jan. 31, 2019

(54) TONER EXTERNAL ADDITIVE, ELECTROSTATIC CHARGE IMAGE DEVELOPING TONER, AND ELECTROSTATIC CHARGE IMAGE DEVELOPER

(71) Applicant: FUJI XEROX CO., LTD., Tokyo (JP)

(72) Inventors: Moegi IGUCHI, Kanagawa (JP); Yutaka SAITO, Kanagawa (JP); Sakon TAKAHASHI, Kanagawa (JP); Mona TASAKI, Kanagawa (JP); Soutaro KAKEHI, Kanagawa (JP); Yuka YAMAGISHI, Kanagawa (JP)

(73) Assignee: FUJI XEROX CO., LTD., TOKYO (JP)

(21) Appl. No.: 15/985,707

(22) Filed: May 22, 2018

(30) Foreign Application Priority Data
Jul. 28, 2017 (JP) 2017-147248

(51) Int. Cl. G03G 9/097; G03G 9/08; G03G 9/113

(52) U.S. Cl. CPC G03G 9/09716; G03G 9/0821; G03G 9/08755; G03G 9/1132; G03G 9/0819

(57) ABSTRACT

Provided is a toner external additive including: a strontium titanate particle which has a hydrophobized surface, in which an average primary particle diameter is 10 nm or more and 100 nm or less, and a specific volume resistivity R1 is 11 or more and 14 or less in terms of a common logarithm value log R1.

### CROSS-REFERENCE TO RELATED APPLICATIONS

This application is based on and claims priority under 35 USC 119 from Japanese Patent Application No. 2017-147248 filed Jul. 28, 2017.

### BACKGROUND

### Technical Field

The present invention relates to a toner external additive, an electrostatic charge image developing toner, and an electrostatic charge image developer.

### SUMMARY

According to an aspect of the present invention, there is provided a toner external additive including a strontium titanate particle which has a hydrophobized surface, in which an average primary particle diameter is 10 nm or more and 100 nm or less, and a specific volume resistivity R1 is 11 or more and 14 or less in terms of a common logarithm value log R1.

### BRIEF DESCRIPTION OF THE DRAWINGS

Exemplary embodiment(s) of the present invention will be described in detail based on the following figures, wherein:

FIG. 1 is a schematic view illustrating a configuration of an image forming device of this exemplary embodiment; and

FIG. 2 is a schematic view illustrating a configuration of a process cartridge of this exemplary embodiment.

### DETAILED DESCRIPTION

An exemplary embodiment of the invention is described below. These descriptions and examples exemplify these exemplary embodiments and do not limit the scope of the invention.

In the present disclosure, in a case of referring to the amount of each component in the composition, in a case where there are plural kinds of substances corresponding to each component in the composition, unless described otherwise, the amount means a total amount of plural substances.

According to the present specification, the numerical range expressed by using “to” means a range including numerical values described before and after “to” as a minimum value and a maximum value.

In the present disclosure, the “toner external additive” may be simply referred to as an “external additive”, the “electrostatic charge image developing toner” may be simply referred to as a “toner”, and the “electrostatic charge image developer” may be simply referred to as a “developer”.

Toner External Additive

The toner external additive according to this exemplary embodiment is described.

The external additive according to this exemplary embodiment includes a strontium titanate particle (hereinafter, referred to as a specific strontium titanate particle) which has a hydrophobized surface, in which an average primary particle diameter is 10 nm or more and 100 nm or less, and in which a specific volume resistivity R1 is 11 or more and 14 or less in terms of a common logarithm value log R1.

The strontium titanate particle has a perovskite crystal structure (cube or rectangle) and thus is a particle having high crystallinity and high resistance. The strontium titanate particle uses this crystal structure to be used as an abrasive.

However, it has been found that, in a case where the strontium titanate particle having high resistance is used as a toner external additive, fogging (phenomenon in which a toner adheres to a non-image area) may occur during continuous printing. This is because, since the strontium titanate particle having high resistance has slow responsiveness of charge exchange, in a case where triboelectric charging is repeated by continuous printing, the charging of the toner is increased, and, in a case where the toner having low charging is added to this, mutual charging between toners occurs, but the charge exchange between the both does not efficiently occur, such that the toner becomes a toner having wide charging distribution.

Meanwhile, in a case where the resistance of the strontium titanate particle becomes too low (for example, a common logarithm value of the specific volume resistivity is less than 11), a charge charged in the toner leaks, the toner is not sufficiently charged, and fogging occurs.

The external additive according to this exemplary embodiment includes a strontium titanate particle (a specific strontium titanate particle) which has a hydrophobized surface, in which an average primary particle diameter is 10 nm or more and 100 nm or less, and in which a specific volume resistivity R1 is 11 or more and 14 or less in terms of a common logarithm value log R1.

In a case where the external additive including this specific strontium titanate particle is used, fogging occurring during continuous printing is suppressed. The reasons are assumed as follows.

The specific volume resistivity R1 of the specific strontium titanate particle is lower than the strontium titanate particle having a perovskite crystal structure (cube or rectangle). Therefore, the specific strontium titanate particle has satisfactory charge exchange properties, and thus even in a case where continuous printing is performed, the charging distribution of the toner is suppressed from spreading.

The specific strontium titanate particle has a hydrophobized surface exhibiting high resistance. Since the specific strontium titanate particle has high resistance on the surface, the charged charge of the toner is suppressed from leaking.

It is understood that the specific strontium titanate particle has an average primary particle diameter as above and has a small diameter. Therefore, the specific strontium titanate particle is easily dispersed on the surface of the toner particle, and the coating amount is easily increased. As a result, widening of the charging distribution of the toner and leaking of the charged charge of the toner are easily suppressed.

Hereinafter, the specific strontium titanate particle is specifically included in the external additive according to this exemplary embodiment.

Specific Strontium Titanate Particle

Hydrophobized Surface

The specific strontium titanate particle is a strontium titanate particle having a hydrophobized surface. That is, the specific strontium titanate particle is a particle obtained by hydrophobizing the surface of the (untreated) strontium titanate particle.

In this manner, since the specific strontium titanate particle has hydrophobized surface so as to have high resistance on the surface, the charged charge of the toner is suppressed from leaking.

Since the resistance can be increased, the hydrophobized surface of the specific strontium titanate particle is preferably surface-treated with a silicon-containing organic compound, for example. Examples of the silicon-containing organic compound include an alkoxysilane compound, a silazane compound, and silicone oil. Among these, at least one selected from an alkoxysilane compound and silicone oil is preferable, for example.

The silicon-containing organic compound is specifically described in the section of the method of manufacturing the specific strontium titanate particle.

With respect to the hydrophobized surface of the specific strontium titanate particle, in view of obtaining the target specific volume resistivity R1 and obtaining the specific strontium titanate particle having sharp particle size distribution, a mass ratio (Si/Sr) of silicon (Si) and strontium (Sr) calculated from qualitative and quantitative analysis of fluorescent X-ray analysis is preferably 0.025 or more and 0.25 or less and more preferably 0.05 or more and 0.20 or less, for example.

Here, the fluorescent X-ray analysis of the hydrophobized surface of the specific strontium titanate particle is performed by the following method.

That is, qualitative and quantitative analysis measurement is performed by using a fluorescent X-ray analyzer (XRF 1500 manufactured by Shimadzu Corporation) under conditions of X-ray output of 40 V, 70 mA, measurement area of 10 mmφ, and measurement time of 15 minutes. Here, the analyzed elements are oxygen (O), silicon (Si), titanium (Ti), strontium (Sr), and metal elements (Me) other than titanium and strontium, and mass ratios (%) of respective elements are calculated with reference to calibration curve data and the like which may quantify the respective elements separately prepared from the total of the measured elements.

The mass ratio (Si/Sr) is calculated based on the value of a mass ratio of silicon (Si) and a mass ratio of strontium (Sr) that may be obtained in this measurement.

Average Primary Particle Diameter

In view of improving dispersibility and coverage with respect to toner particles and in view of easily controlling an isolation proportion to toner particles within the range, an average primary particle diameter of the specific strontium titanate particle is 10 nm or more and 100 nm or less. In view of charge maintainability with time, the average primary particle diameter is more preferably 20 nm or more and 80 nm or less, even more preferably 20 nm or more and 60 nm or less, and even more preferably 30 nm or more and 60 nm or less, for example.

The primary particle diameter of specific strontium titanate particle in this exemplary embodiment is the diameter (so-called circle equivalent diameter) of a circle having an area the same as the primary particle image, and the average primary particle diameter of specific strontium titanate particles is a particle diameter which becomes 50% of accumulation from the small diameter side in the distribution of primary particle diameters based on the number.

The average primary particle diameter of the specific strontium titanate particle is measured, for example, by a method below.

First, after the specific strontium titanate particle is dispersed on the surface of the resin particle (polyester, weight-average molecular weight Mw=50,000) having a volume average particle diameter of 100 μm, the specific strontium titanate particle is observed at a magnification of 40,000 times with a scanning electron microscope (SEM), and 300 primary particles of the strontium titanate particle in one visual field is randomly specified. The equivalent circle diameter of each of 300 primary particles is obtained by the image analysis using the specified strontium titanate particles with image analysis software.

The circle equivalent diameter which becomes 50% of the accumulation from the small diameter side in the number-based distribution of 300 primary particles is obtained.

Here, S-4800 manufactured by Hitachi High-Technologies Corporation is used as a scanning electron microscope, and measurement conditions are an acceleration voltage of 15 kV, an emission current of 20 μA, and WD of 15 mm. As image analysis software, the image processing analysis software WinRoof (Mitani Corporation) is used.

The average primary particle diameter of the specific strontium titanate particle may be controlled, for example, by various conditions in a case where the strontium titanate particle is manufactured by a wet process.

Specific Volume Resistivity R1

With respect to the specific strontium titanate particle, in view of obtaining a charging amount of the toner and easily suppressing of the fogging occurred during continuous printing, the specific volume resistivity R1 is 11 or more and 14 or less, more preferably 11 or more and 13 or less, and even more preferably 12 or more and 13 or less in terms of the common logarithm value log R1, for example.

According to this exemplary embodiment, the specific volume resistivity R1 of the specific strontium titanate particle is measured as follows.

A strontium titanate particle is put on a lower electrode plate of a measuring holding device which is a pair of circular electrode plates (made of steel) of 20 cm² which are connected to an electrometer (Trade name: KEITHLEY 610C, manufactured by KEITHLEY, Inc.) and a high voltage power supply (Trade name: FLUKE 415 B, manufactured by FLUKE Corporation) so as to form a flat layer having a thickness of 1 mm or more and 2 mm or less.

Thereafter, the formed strontium titanate particle layer is humidified at 22° C. and 55% RH for 24 hours.

Next, after an upper electrode plate is disposed on the humidified strontium titanate particle layer in the environment of 22° C. and 55% RH, 4 kg of a weight is placed on the upper electrode plate in order to remove a cavity in the strontium titanate particle layer, and the thickness of the strontium titanate particle layer is measured in that state.

Subsequently, a voltage of 1,000 V is applied to both the electrode plates, and the current value is measured, so as to calculate the specific volume resistivity based on Equation (1).

Specific Volume Resistivity R1=V×S/A−A₀)/d (Ωcm) Equation (1)

In Equation (1), V is an applied voltage of 1,000 (V), S is an electrode plate area of 20 (cm²), A is a measured current value (A), A₀ is an initial current value (A) in a case where an applied voltage is 0 V, and d is a thickness (cm) of the strontium titanate particle layer.

In this exemplary embodiment, the common logarithm value log R1 of the specific volume resistivity R1 obtained by the method is employed.

The specific volume resistivity R1 of the specific strontium titanate particle may be controlled, for example, by the volume resistivity R2 (changed according to a moisture content, a type of a metal element (above, referred to as a dopant) other than titanium and strontium, an added amount of a dopant, or the like) of the strontium titanate particle before the surface treatment, a type of a hydrophobic treatment agent, a hydrophobic treatment amount, a drying temperature after the surface treatment (hydrophobic treatment), drying time, or the like. Particularly, it is preferable that the specific volume resistivity R1 is controlled by at least one of the moisture content of the strontium titanate particle before the surface treatment or the hydrophobic treatment amount, for example.

Resistance Component R and Capacitance Component C Obtained by Impedance Method

The present inventors have found that, according to the impedance method, the charge transfer rate (that is, the degree of charge exchangeability) in a case where the alternating current voltage is applied to the specific strontium titanate particle may be confirmed by changing the frequency under the alternating current voltage, measuring the responsiveness, and using the impedance method.

The present inventors have found that, in a case where values of the resistance component R and the capacitance component C (particularly, a value of the capacitance component C) obtained by the impedance method of the specific strontium titanate particle are controlled, the target charge exchangeability may be obtained and the leakage of the charged charges of the toner may be suppressed.

With respect to the specific strontium titanate particle, in view of easiness of suppressing the leakage of the charged charge of the toner, high charge exchangeability, and easiness of suppressing fogging generated at continuous printing, the resistance component R and the capacitance component C during the measurement by the impedance method preferably satisfy Expressions (a) and (b) and more preferably satisfy Expressions (a1) and (b1), for example.

8≤common logarithm value log R of resistance component R≤10 Expression (a)

−11≤common logarithm value log C of capacitance component C≤−9.5 Expression (b)

8.5≤common logarithm value log R of resistance component R≤9.5 Expression (a1)

−10.5≤common logarithm value log C of capacitance component C≤−9.5 Expression (b2)

In this exemplary embodiment, the resistance component R and the capacitance component C obtained by the impedance method are measured as follows.

First, an impedance analyzer (1260 type manufactured by Solartron) and a dielectric constant measuring interface (1296 type manufactured by Solartron) are used as a power source and an ammeter. 1 g of strontium titanate particles is introduced into a sample holder, left to stand for 15 minutes with a load of 0.1 MPa applied, and connected to an ammeter and a dielectric constant interface, and an AC voltage is applied to strontium titanate so as to perform measure impedance. The measurement condition is as below.
Direct current applied voltage: 3 V
Alternating current applied voltage: 1 V
Frequency: from 10 MHz to 10 mHz

From the measurement result, the resistance component R and the capacitance component C are calculated by Cole-Cole plot analysis. As analysis software, Zview Ver. 3.1c (manufactured by Scribner Associates Inc.) is used.

The resistance component R and the capacitance component C by the impedance method of the specific strontium titanate particle may be controlled by the same factor as the specific volume resistivity R1. Particularly, the capacitance component C is preferably controlled by using at least one of a type of the dopant in the strontium titanate particle before the surface treatment, or an added amount of the dopant, for example.

Specific Volume Resistivity R2 of Strontium Titanate Particle Before Hydrophobized Surface is Formed

According to this exemplary embodiment, the specific volume resistivity R2 of the (untreated) strontium titanate particle before the hydrophobized surface is formed is preferably 6 or more and 10 or less and more preferably 7 or more and 9 or less in terms of the common logarithm value log R2, for example.

That is, the inside of the hydrophobized surface of the specific strontium titanate particle has the resistance as above, and the strontium titanate particle becomes particles of which the inside has low resistance and the surface has high resistance due to hydrophobic treatment.

In a case where the specific volume resistivity R2 is in this range, the charging amount of the toner may be sufficiently obtained, and the leakage of the charged electric charge of the toner with time is easily suppressed.

According to this exemplary embodiment, the difference (log R1−log R2) between the common logarithm value log R1 of the specific volume resistivity R1 and the common logarithm value log R2 of the specific volume resistivity R2 is preferably 2 or more and 7 or less and more preferably 3 or more and 5 or less, for example.

In a case where “log R1−log R2” is in the above range, the leakage of the charged charge of the toner with time is easily suppressed, and the widening of the charging distribution of the toner is easily suppressed.

The specific volume resistivity R2 of the (untreated) strontium titanate particle before the hydrophobized surface is formed is measured in the same method as the specific volume resistivity R1 of the specific strontium titanate particle.

The specific volume resistivity R2 of the strontium titanate particle before the hydrophobized surface is formed, for example, may be controlled according to a moisture content of the strontium titanate particle, a type of the dopant, an added amount of the dopant, and the like.

Moisture Content

In view of narrowing down of the charge distribution of the toner and easily suppressing of the leakage of the charged charge of the toner, the moisture content of the specific strontium titanate particle is preferably 1.5 mass % or more and 10 mass % or less and more preferably 2 mass % or more and 5 mass % or less, for example.

The moisture content of the specific strontium titanate particle is measured as follows.

20 mg of the measurement sample is left for 17 hours in a chamber having a temperature of 22° C. and a relative humidity of 55% so as to be humidified and heated from 30° C. to 250° C. at a temperature rise rate of 30° C./min in a nitrogen gas atmosphere by a thermobalance (TGA-50 type manufactured by Shimadzu Corporation) in a room at a temperature of 22° C. and a relative humidity of 55%, so as to measure a heating loss (mass lost by heating).

The moisture content is calculated by the following formula based on the measured heating loss.

Moisture content (mass %)=(Heating loss from 30° C. to 250° C.)/(mass after humidification before heating)×100

The moisture content of the specific strontium titanate particle may be controlled by the manufacturing of the strontium titanate particle by a wet process, various conditions during a wet process, types of the hydrophobic treatment agent, the hydrophobic treatment amount, and the like.

Dope of Metal Element in Addition to Titanium and Strontium

In the specific strontium titanate particle, the strontium titanate particle (strontium titanate particle before a hydrophobized surface 30 is forming) inside the hydrophobized surface is preferably doped with a metal element (dopant) in addition to titanium and strontium, for example.

In a case where the strontium titanate particle includes a dopant, the crystallinity of the perovskite structure is decreased, and thus the resistance decreases such that the specific volume resistivity R1, the specific volume resistivity R2, and the capacitance component C by the impedance method are easily controlled in the above range.

The dopant used in the strontium titanate particle is not particularly limited, as long as the dopant is a metal element other than titanium and strontium.

Specific examples of the dopant include lanthanoid, silica, aluminum, calcium, magnesium, barium, phosphorus, sulfur, vanadium, chromium, manganese, iron, cobalt, nickel, copper, gallium, yttrium, zinc, niobium, molybdenum, ruthenium, rhodium, palladium, silver, indium, tin, antimony, tantalum, tungsten, rhenium, osmium, iridium, platinum, bismuth, and zirconium. As the lanthanoid, lanthanum and cerium are preferable, for example. Among these, for example, lanthanum is preferable because the specific strontium titanate particles are easily doped.

With respect to the dopant, in view of easily controlling the specific volume resistivity R1, the specific volume resistivity R2, and the capacitance component C by the impedance method, a metal element in which the electronegativity as the value of Allred-Rochow is 2 or less and is preferably 1.3 or less is preferable, for example.

Preferable metal elements having electronegativity of 2.0 or less are provided below together with electronegativity, for example.

Examples of the metal element having an electronegativity of 2.0 or less include lanthanum (1.08), magnesium (1.23), aluminum (1.47), silica (1.74), calcium (1.04), vanadium (1.45), chromium (1.56), manganese (1.60), iron (1.64), cobalt (1.70), nickel (1.75), copper (1.75), zinc (1.66), gallium (1.82), yttrium (1.11), zirconium (1.22), niobium (1.23), silver (1.42), indium (1.49), tin (1.72), barium (0.97), tantalum (1.33), rhenium (1.46), and cerium (1.06).

The amount of the dopant in the strontium titanate particle is appropriately adjusted according to the desired values of the specific volume resistivity R1, the specific volume resistivity R2, and the capacitance component C by the impedance method, and, for example, the dopant with respect to strontium is preferably in the range of 0.1 mol % or more and 20 mol % or less, more preferably in the range of 0.1 mol % or more and 15 mol % or less, and even more preferably in the range of 0.1 mol % or more and 10 mol % or less.

Method of Manufacturing Specific Strontium Titanate Particle

The specific strontium titanate particle is manufactured by hydrophobizing the surface of the strontium titanate particle.

The method of manufacturing the strontium titanate particle is not particularly limited but is preferably a wet process in view of controlling a particle diameter and a shape, for example.

Manufacturing Strontium Titanate Particle

The wet process of the strontium titanate particle is a manufacturing method of performing reaction while an aqueous alkaline solution is added to a mixed solution of a titanium oxide source and a strontium source and then performing an acid treatment. In this manufacturing method, the particle diameter of the strontium titanate particles is controlled by a mixing ratio of the titanium oxide source and the strontium source, a concentration of the titanium oxide source at the initial stage of the reaction, the temperature and the addition rate in a case of adding the aqueous alkaline solution, and the like.

As a titanium oxide source, for example, a mineral acid peptized product of a hydrolyzate of a titanium compound is preferable. Examples of the strontium source include strontium nitrate and strontium chloride.

The mixing ratio of the titanium oxide source and the strontium source is preferably 0.9 or more and 1.4 or less and more preferably 1.05 or more and 1.20 or less in a molar ratio of SrO/TiO₂, for example. The concentration of the titanium oxide source in the initial stage of the reaction is preferably 0.05 mol/L or more and 1.3 mol/L or less and more preferably 0.5 mol/L or more and 1.0 mol/L or less as TiO₂, for example.

In order to adjust the resistance of the strontium titanate particle, it is preferable to add a dopant source to the mixed solution of the titanium oxide source and the strontium source, for example. Examples of the dopant source include an oxide of metal other than titanium and strontium. The metal oxide as the dopant source is added as a solution dissolved in, for example, nitric acid, hydrochloric acid, sulfuric acid, or the like. The addition amount of the dopant source is preferably an amount in which metal which is a dopant is 0.1 moles or more and 20 moles or less and more preferably an amount in which metal is 0.5 moles or more and 10 moles or less with respect to 100 moles of strontium, for example.

The dopant source may be added in a case where the aqueous alkaline solution is added to the mixed solution of the titanium oxide source and the strontium source. Also in that case, the metal oxide of the dopant source may be added as a solution of being dissolved in nitric acid, hydrochloric acid, or sulfuric acid.

As the aqueous alkaline solution, for example, an aqueous sodium hydroxide solution is preferable. There is a tendency in that, as the temperature in a case of adding the aqueous alkaline solution becomes higher, a strontium titanate particle having more satisfactory crystallinity may be obtained. Therefore, in order to obtain the desired specific volume resistivity R1 and the desired specific volume resistivity R2, according to this exemplary embodiment, the temperature is preferably in the range of 60° C. or higher and 100° C. or lower, for example.

With respect to the addition rate of the aqueous alkaline solution, as the addition rate is lower, the strontium titanate particle having a larger particle diameter may be obtained, and as the addition rate is higher, the strontium titanate particle having a smaller particle diameter may be obtained. The addition rate of the aqueous alkaline solution, for example, is 0.001 equivalent/h or more and 1.2 equivalent/h or less and appropriately 0.002 equivalent/h or more and 1.1 equivalent/h or less with respect to the introduced raw material.

After the aqueous alkaline solution is added, an acid treatment is performed for the purpose of removing the unreacted strontium source. The acid treatment, for example, is performed by using, hydrochloric acid, and pH of the reaction solution is adjusted from 2.5 to 7.0 and more preferably from 4.5 to 6.0.

After the acid treatment, the reaction solution is subjected to solid-liquid separation, and the solid content is subjected to a dry treatment, so as to obtain a strontium titanate particle.

Surface Treatment

The surface treatment of the strontium titanate particle is performed, for example, by preparing a treatment liquid obtained by mixing a solvent and a silicon-containing organic compound that is a hydrophobic treatment agent, mixing the strontium titanate particle and the treatment liquid under stirring, and further performing stirring continuously.

After the surface treatment, the drying treatment is performed for the purpose of removing the solvent of the treatment liquid.

Examples of the silicon-containing organic compound that is a hydrophobic treatment agent include an alkoxysilane compound, a silazane compound, and silicone oil.

Examples of the alkoxysilane compound which is a hydrophobic treatment agent include tetramethoxysilane and tetraethoxysilane; methyltrimethoxysilane, ethyl trimethoxysilane, propyl trimethoxysilane, butyl trimethoxysilane, hexyltrimethoxysilane, n-octyltrimethoxysilane, decyltrimethoxysilane, dodecyltrimethoxysilane, vinyl triethoxysilane, methyltriethoxysilane, ethyltriethoxysilane, butyl triethoxysilane, hexyltriethoxysilane, decyltriethoxysilane, dodecyltriethoxysilane, phenyltrimethoxysilane, o-methylphenyltrimethoxysilane, p-methylphenyltrimethoxysilane, phenyltriethoxysilane, and benzyltriethoxysilane; dimethyl dimethoxysilane, dimethyl diethoxysilane, methyl vinyl dimethoxysilane, methyl vinyl diethoxysilane, diphenyldimethoxysilane, and diphenyldiethoxysilane; trimethylmethoxysilane, and trimethylethoxysilane.

Examples of the silazane compound that is a hydrophobilizing agent include dimethyl disilazane, trimethyldisilazane, tetramethyldisilazane, pentamethyldisilazane, and hexamethyldisilazane.

Examples of the silicone oil which is the hydrophobic treatment agent include silicone oil such as dimethyl polysiloxane, diphenyl polysiloxane, and phenylmethyl polysiloxane; reactive silicone oil such as amino-modified polysiloxane, epoxy-modified polysiloxane, carboxyl-modified polysiloxane, carbinol-modified polysiloxane, fluorine-modified polysiloxane, methacryl-modified polysiloxane, mercapto-modified polysiloxane, and phenol-modified polysiloxane.

Among these, as the hydrophobizing agent, in view of the charging environment difference and the improvement of fluidity, it is preferable to use an alkoxysilane compound, for example. Particularly, in view of the charging environment difference, butyltrimethoxysilane is preferable, for example.

As the solvent used for preparing the treatment liquid, an alcohol (for example, methanol, ethanol, propanol, and butanol) is preferable in a case where the silicon-containing organic compound is an alkoxysilane compound or a silazane compound, for example, and hydrocarbon (for example, benzene, toluene, normal hexane, and normal heptane) is preferable in a case where the silicon-containing organic compound is silicone oil, for example.

In the treatment liquid, the concentration of the silicon-containing organic compound is preferably 1 mass % or more and 50 mass % or less, more preferably 5 mass % or more and 40 mass % or less, and even more preferably 10 mass % or more and 30 mass % or less, for example.

The amount of the silicon-containing organic compound used for the surface treatment may be determined according to the desired specific volume resistivity R1 or the like, and is preferably 1 part by mass or more and 50 parts by mass or less, more preferably 5 parts by mass or more and 40 parts by mass or less, and even more preferably 5 parts by mass or more and 30 parts by mass or less with respect to 100 parts by mass of the strontium titanate particle, for example.

The moisture content of the strontium titanate particle is preferably controlled by adjusting the condition of the dry treatment after the surface treatment is performed, for example.

Here, as the dry condition in a case of controlling the moisture content, it is preferable that, for example, the drying temperature is 90° C. or more and 300° C. or less (preferably, for example, 100° C. or more and 150° C. or less), and the drying time is 1 hour or more and 15 hours or less (preferably, for example, 5 hours or more and 10 hours or less).

As above, the strontium titanate particle having the hydrophobic treatment surface may be obtained.

Externally Added Amount

The external addition amount of the strontium titanate particle is preferably 0.1 parts by mass or more and 5 parts by mass or less, more preferably 0.5 parts by mass or more and 3 parts by mass or less, and even more preferably 0.7 parts by mass or more and 2 parts by mass or less with respect to 100 parts by mass of the toner particle, for example.

Particle other than Specific Strontium Titanate Particle

The toner external additive according to this exemplary embodiment may include the particle other than the specific strontium titanate particle, in the range of not deteriorating the effect of suppressing the fogging generated during continuous printing.

Examples of the other particle include a strontium titanate particle (referred to as an untreated strontium titanate particle) that does not have the hydrophobized surface and other inorganic particles.

Examples of the other inorganic particle include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O—(TiO₂) n, Al₂O₃.2SiO₂, CaCO₃, MgCO₃, BaSO₄, and MgSO₄.

The surface of the inorganic particle as the external additive may be subjected to the hydrophobic treatment. For example, the hydrophobic treatment is performed by immersing an inorganic particle to the hydrophobic treatment agent, or the like. The hydrophobic treatment agent is not particularly limited, but examples thereof include a silane coupling agent, a silicone oil, a titanate coupling agent, and an aluminum coupling agent. These may be used singly, and two or more kinds thereof may be used in combination.

The amount of the hydrophobic treatment agent is generally 1 part by mass or more and 10 parts by mass or less with respect to 100 parts by mass of the inorganic particle.

Examples of the other particle include a resin particle (a resin particle such as polystyrene, polymethyl methacrylate, and melamine resin) and a cleaning activator (for example, a particle of a fluorine-based high molecular weight substance).

In the external additive according to this exemplary embodiment, in a case of including a particle other than the specific strontium titanate particle, the content of the particle other than the specific strontium titanate particle in the entire particle is preferably 15 mass % or less, more preferably 3 mass % or more and 10 mass % or less, and even more preferably 4 mass % or more and 8 mass % or less, for example.

Electrostatic Charge Image Developing Toner

The electrostatic charge image developing toner according to this exemplary embodiment has a toner particle and a toner external additive including the specific strontium titanate particle.

Hereinafter, the configuration of the toner according to this exemplary embodiment is specifically described.

Toner Particle

Examples of the toner particle include a binder resin and, if necessary, a colorant, a releasing agent, and other additives.

Binder Resin

Examples of the binder resin include a homopolymer of a monomer such as styrenes (for example, styrene, parachlorostyrene, and α-methylstyrene), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), and olefins (for example, ethylene, propylene, and butadiene), or a vinyl-based resin including a copolymer obtained by combining two or more of these monomers.

Examples of the binder resin include a non-vinyl based resin such as an epoxy resin, a polyester resin, a polyurethane resin, a polyamide resin, a cellulose resin, a polyether resin, and a modified rosin, a mixture of these and the vinyl-based resin, or a graft polymer obtained by polymerizing a vinyl-based monomer in the coexistence thereof.

The binder resin may be used singly, and two or more kinds thereof may be used in combination.

The binder resin is not particularly limited and is preferably a polyester resin, for example. Examples of the polyester resin include a condensation polymer of polyvalent carboxylic acid and polyhydric alcohol.

Examples of the polyvalent carboxylic acid include aliphatic dicarboxylic acid (for example, oxalic acid, malonic acid, maleic acid, fumaric acid, citraconic acid, itaconic acid, glutaconic acid, succinic acid, alkenylsuccinic acid, adipic acid, and sebacic acid), alicyclic dicarboxylic acid (such as cyclohexanedicarboxylic acid), aromatic dicarboxylic acid (for example, terephthalic acid, isophthalic acid, phthalic acid, and naphthalene dicarboxylic acid), anhydrides thereof, or lower alkyl ester (for example, having 1 to 5 carbon atoms) thereof. Among these, as the polyvalent carboxylic acid, for example, aromatic dicarboxylic acid is preferable.

As the polyvalent carboxylic acid, trivalent or higher valent carboxylic acid having a crosslinked structure or a branched structure may be used together with the dicarboxylic acid. Examples of the trivalent or higher valent carboxylic acid include trimellitic acid, pyromellitic acid, anhydrides thereof, or lower alkyl esters (for example, having 1 to 5 carbon atoms) thereof.

The polyvalent carboxylic acid may be used singly and two or more kinds thereof may be used in combination.

Examples of the polyhydric alcohol include aliphatic diol (for example, ethylene glycol, diethylene glycol, triethylene glycol, propylene glycol, butanediol, hexanediol, and neopentyl glycol), alicyclic dial (for example, cyclohexanediol, cyclohexane dimethanol, and hydrogenated bisphenol A), aromatic dial (for example, an ethylene oxide adduct of bisphenol A and a propylene oxide adduct of bisphenol A). Among these, for example, the polyhydric alcohol is preferably aromatic diol or alicyclic diol and more preferably aromatic diol.

As the polyhydric alcohol, trivalent or higher valent polyhydric alcohol having a crosslinked structure or a branched structure may be used together with diol. Examples of trihydric or higher hydric polyhydric alcohol include glycerin, trimethylolpropane, and pentaerythritol.

The polyhydric alcohol may be used singly and two or more kinds thereof may be used in combination.

The glass transition temperature (Tg) of the polyester resin is preferably 50° C. or more and 80° C. or less and more preferably 50° C. 65° C. or less, for example.

The glass transition temperature is calculated from the DSC curve obtained by the differential scanning calorimetry (DSC), more specifically, is obtained from “Extrapolated glass transition temperature” disclosed in the method of obtaining the glass transition temperature of “Method of measuring transition temperature of plastic” of JIS K 7121-1987.

The weight-average molecular weight (Mw) of the polyester resin is preferably 5,000 or more and 1,000,000 or less and more preferably 7,000 or more and 500,000 or less, for example. The number-average molecular weight (Mn) of the polyester resin is preferably 2,000 or more and 100,000 or less, for example. The molecular weight distribution Mw/Mn of the polyester resin is preferably 1.5 or more and 100 or less and more preferably 2 or more and 60 or less, for example.

The weight-average molecular weight and the number-average molecular weight of the polyester resin are measured by gel permeation chromatography (GPC). Measuring of the molecular weight by GPC is performed in a THF solvent by using GPC⋅HLC-8120 GPC manufactured by Tosoh Corporation as a measuring device and using TSK gel SuperHM-M (15 cm) manufactured by Tosoh Corporation. The weight-average molecular weight and the number-average molecular weight are calculated by using a molecular weight calibration curve prepared from a monodispersed polystyrene standard sample from this measurement result.

The polyester resin may be obtained by the well-known manufacturing method. Specifically, the polyester resin may be obtained, for example, by the method of setting the polymerization temperature to be 180° C. or more and 230° C. or less, depressurizing the inside of the reaction system if necessary, and performing the reaction while removing water and alcohol generated during the condensation.

In a case where the monomer of the raw material does not dissolve or compatibilize at the reaction temperature, a solvent having a high boiling point may be added as a dissolution aid for dissolving. In this case, the polycondensation reaction is performed while the dissolution aid is distilled off. In a case where a monomer with bad compatibility is present, the monomer having bad compatibility and the acid or alcohol to be polycondensed with the monomer may be condensed with each other in advance, so as to be polycondensed with the major component.

The content of the binder resin is preferably 40 mass % or more and 95 mass % or less, more preferably 50 mass % or more and 90 mass % or less, and even more preferably 60 mass % or more and 85 mass % or less with respect to the entire toner particle, for example.

Colorant

Examples of the colorant include pigments such as carbon black, chrome yellow, hansa yellow, benzidine yellow, suren yellow, quinoline yellow, pigment yellow, permanent orange GTR, pyrazolone orange, vulcan orange, watch young red, permanent red, brilliant carmine 3B, brilliant carmine 6B, dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as acridine-based, xanthene-based, azo-based, benzoquinone-based, azine-based, anthraquinone-based, thioindigo-based, dioxazine-based, thiazine-based, azomethine-based, indico-based, phthalocyanine-based, aniline black-based, polymethine-based, triphenyl methane-based, diphenylmethane-based, and thiazole-based dyes.

The colorant may be used singly and two or more kinds thereof may be used in combination.

As the colorant, if necessary, a surface-treated colorant may be used or a dispersing agent may be used in combination. Plural colorants may be used in combination.

The content of the colorant is preferably 1 mass % or more and 30 mass % or less and more preferably 3 mass % or more and 15 mass % or less with respect to the entire toner particle, for example.

Releasing Agent

Examples of the release agent include hydrocarbon wax; natural wax such as carnauba wax, rice wax, and candelilla wax; synthetic or mineral/petroleum wax such as montan wax; and ester type wax such as fatty acid ester and montanic acid ester. The releasing agent is not limited thereto.

The melting temperature of the releasing agent is preferably 50° C. or more and 110° C. or less and more preferably 60° C. or more and 100° C. or less, for example.

The melting temperature is calculated from the DSC curve obtained by the differential scanning calorimetry (DSC) by “Melting peak temperature” disclosed in the method of obtaining the melting temperature of “Method of measuring transition temperature of plastic” of JIS K 7121-1987.

The content of the releasing agent is preferably 1 mass % or more and 20 mass % or less and more preferably 5 mass % or more and 15 mass % or less with respect to the entire toner particle, for example.

Other Additives

Examples of other additives include well-known additives such as a magnetic material, a charge control agent, and an inorganic powder. These additives are included in the toner particle as an internal additive.

Properties of Toner Particle

The toner particle may be a toner particle of a single layer structure or may be a toner particle of a so-called core-shell structure including a core part (core particle) and a coating layer (shell layer) coating the core part. The toner particle of a core-shell structure, for example, includes a core part including a binder resin and, if necessary, a colorant, a releasing agent, and the like, and a coating layer including a binder resin.

The volume average particle diameter (D50v) of the toner particle is preferably 2 μm or more and 10 μm or less and more preferably 4 μm or more and 8 μm or less, for example.

The volume average particle diameter of the toner particle is measured using COULTER MULTISIZER II (manufactured by Beckman Coulter, Inc.) and using ISOTON-II (manufactured by Beckman Coulter, Inc.) as an electrolytic solution.

In the measurement, 0.5 mg or more and 50 mg or less of a measurement sample is added to 2 ml of a 5 mass % aqueous solution of a surfactant (preferably sodium alkylbenzenesulfonate, for example) as a dispersing agent. This is added to 100 ml or more and 150 ml or less of the electrolytic solution.

A dispersion treatment of the electrolytic solution in which the sample is suspended is performed for one minute with an ultrasonic disperser, and each of the particle diameters of the particle having a particle diameter in the range of 2 μm to 60 μm is measured by using an aperture of 100 μm by COULTER MULTISIZER II. The number of sampling particles is 50,000.

With respect to the measured particle diameter, the cumulative volume-based distribution is drawn from the small diameter side, and the particle diameter at which the accumulation becomes 50% is defined as the volume average particle diameter D50v.

A shape factor SF1 of the toner particle is preferably 110 or more and 150 or less and more preferably 120 or more and 140 or less, for example.

The shape factor SF1 is obtained by the following equation.

SF1=(ML²/A)×(π/4)×100 Equation:

In the equation, ML is an absolute maximum length of the toner, and A is the projected area of the toner.

Specifically, the shape factor SF1 is digitized by analyzing a microscopic image or a scanning electron microscope (SEM) image by using an image analyzer and is calculated as follows. That is, an optical microscopic image of particles scattered on the surface of the slide glass is introduced into a RUZEX image analyzer by a video camera, the maximum length and the projected area of 100 particles are obtained and calculated by the above equation, and the average value is calculated so as to obtain the shape factor SF1.

Method of Manufacturing Toner

Subsequently, the method of manufacturing the toner according to this exemplary embodiment is described.

The toner according to this exemplary embodiment may be obtained by manufacturing the toner particle and externally adding the external additive with respect to the toner particle.

The toner particle may be manufactured by any one of a dry process (for example, a kneading pulverization method) and a wet process (for example, an aggregation coalescence method, a suspension polymerization method, and a dissolution suspension method). These processes are not particularly limited, and well-known processes are employed. Among these, toner particles may be obtained by a coagulation coalescence method.

Specifically, for example, in a case where toner particles are manufactured by an aggregation coalescence method, the toner particles are manufactured through a step of (a resin particle dispersion preparation step) of preparing a resin particle dispersion in which resin particles to be a binder resin are dispersed, a step of aggregating the resin particles (other particles, if necessary) in the resin particle dispersion (in a dispersion after other particles are mixed, if necessary) to form aggregated particles, and a step (coagulation/coalescence step) of heating the aggregated particle dispersion in which the aggregated particles are dispersed, and coagulating and coalescing the aggregated particles to form toner particles.

Hereinafter, respective steps are described.

In the following description, a method for obtaining toner particles including a colorant and a releasing agent is described, but a colorant and a releasing agent are used, if necessary. It is obvious that, other additives other than the colorant and the releasing agent may be used.

Resin Particle Dispersion Preparation Step

Together with the resin particle dispersion in which resin particles to be a binder resin are dispersed, for example, a colorant particle dispersion in which colorant particles are dispersed and a releasing agent particle dispersion in which releasing agent particles are dispersed are prepared.

The resin particle dispersion is prepared, for example, by dispersing resin particles in a dispersion medium by a surfactant.

Examples of the dispersion medium used for the resin particle dispersion include an aqueous medium.

Examples of the aqueous medium include water such as distilled water and ion exchanged water and alcohols. These may be used singly, and two or more kinds thereof may be used in combination.

Examples of the surfactant include an anionic surfactant such as sulfate ester salt-based, sulfonate-based, phosphate ester-based, and soap-based surfactants; a cationic surfactant such as amine salt-based and quaternary ammonium salt-based surfactants; and a nonionic surfactant such as polyethylene glycol-based, alkylphenol ethylene oxide adduct-based, and polyhydric alcohol-based surfactants. Among these, particularly, an anionic surfactant and a cationic surfactant are exemplified. The nonionic surfactant may be used together with an anionic surfactant and a cationic surfactant.

The surfactant may be used singly, and two or more kinds thereof may be used in combination.

With respect to the resin particle dispersion, examples of the method of dispersing the resin particles in a dispersion medium, for example, include a general dispersing method such as a rotary shearing type homogenizer, a ball mill, a sand mill, and a dyno mill having a medium. According to the types of the resin particle, the resin particles may be dispersed in the dispersion medium by a phase-transfer emulsification method. The phase-transfer emulsification method is a method of dissolving the resin to be dispersed in a hydrophobic organic solvent in which the resin is soluble and performing phase inversion from W/O to O/W by performing neutralization by adding a base to an organic continuous phase (O phase) and introducing the aqueous medium (W phase), so as to disperse the resin in a particle form in an aqueous medium.

The volume average particle diameter of the resin particle dispersed in the resin particle dispersion is preferably 0.01 μm or more and 1 μm or less, more preferably 0.08 μm or more and 0.8 μm or less, and even more preferably 0.1 μm or more and 0.6 μm or less, for example.

With respect to the volume average particle diameter of the resin particles, the particle diameter which becomes 50% of the accumulation with respect to all the particles is defined as the volume average particle diameter D50v is measured as the volume average particle diameter D50v, by subtracting the cumulative distribution from the small particle diameter side to the volume with respect to the particle size (channel) partitioned by using the particle size distribution obtained by measurement with a laser diffraction type particle size distribution determination device (for example, LA-700, manufactured by Horiba, Ltd.). The volume average particle diameter of the particles in other dispersions is measured in the same manner.

The content of the resin particle of the resin particle dispersion is preferably 5 mass % or more and 50 mass % or less and more preferably 10 mass % or more and 40 mass % or less, for example.

In the same manner as the resin particle dispersion, for example, a colorant particle dispersion and a releasing agent particle dispersion are also prepared. That is, with regard to the volume average particle diameter of the particles in the resin particle dispersion, the dispersion medium, the dispersion method, and the content of the particles, the same is applied to the releasing agent particles dispersed in the colorant particles dispersed in the colorant particle dispersion and the releasing agent particle dispersion.

Aggregated Particle Forming Step

Subsequently, the resin particle dispersion, the colorant particle dispersion, and the releasing agent particle dispersion are mixed. In the mixed dispersion, the resin particles, the colorant particles, and the releasing agent particles are heteroaggregated and aggregated particles including the resin particles, the colorant particles, and the releasing agent particles which has a diameter close to the diameter of the required toner particle are formed.

Specifically, for example, an aggregating agent is added to the mixed dispersion, pH of the mixed dispersion is adjusted to acidity (for example, pH 2 or more and 5 or less), a dispersion stabilizer is added, if necessary, heating is performed to a temperature (specifically, for example, glass transition temperature of resin particles of −30° C. or more and glass transition temperature of −10° C. or less) close to the glass transition temperature of the resin particles, and the particles dispersed in the mixed dispersion are aggregated, so as to form aggregated particles.

In the aggregated particle forming step, for example, heating may be performed after adding an aggregating agent at room temperature (for example, 25° C.) under stirring stirred with a rotary shearing type homogenizer with a rotary shearing type homogenizer, adjusting pH of the mixed dispersion to acidity (for example, pH 2 or more and 5 or less), and adding the dispersion stabilizer, if necessary.

Examples of the aggregating agent include a surfactant having a polarity opposite to that of the surfactant included in the mixed dispersion, inorganic metal salt, and a divalent or higher valent metal complex. In a case where a metal complex is used as the aggregating agent, the amount of the surfactant used is reduced and the chargeability is improved.

Together with the aggregating agent, an additive that forms a complex or a similar bond with a metal ion of the aggregating agent may be used, if necessary. As the additive, a chelating agent is preferably used, for example.

Examples of the inorganic metal salt include metal salt such as calcium chloride, calcium nitrate, barium chloride, magnesium chloride, zinc chloride, aluminum chloride, and aluminum sulfate; and an inorganic metal salt polymer such as polyaluminum chloride, poly aluminum hydroxide, and calcium polysulfide polymer.

As the chelating agent, a water-soluble chelating agent may be used. Examples of the chelating agent include oxycarboxylic acid such as tartaric acid, citric acid, and gluconic acid; and aminocarboxylic acid such as iminodiacetic acid (IDA), nitrilotriacetic acid (NTA), and ethylenediaminetetraacetic acid (EDTA).

The addition amount of the chelating agent is preferably 0.01 parts by mass or more and 5.0 parts by mass or less and more preferably 0.1 parts by mass or more and less than 3.0 parts by mass with respect to 100 parts by mass of the resin particle, for example.

Coagulation Coalescence Step

Next, the aggregated particle dispersion in which the aggregated particles are dispersed is heated, for example, to be equal to or higher than the glass transition temperature of the resin particles (for example, higher than the temperature higher than the glass transition temperature of the resin particles by 10° C. to 30° C.), and the aggregated particles are coagulated and coalesced, so as to form the toner particles.

The toner particles may be obtained through the above steps.

The toner particles may be manufactured through a step of obtaining an aggregated particle dispersion in which the aggregated particles are dispersed, further mixing the aggregated particle dispersion and the resin particle dispersion in which the resin particles are dispersed, and aggregating such that the resin particles are further adhered to the surface of the aggregated particles, to form the second aggregated particles and a step of heating the second aggregated particle dispersion in which the second aggregated particles are dispersed, and coagulating and coalescing of the second aggregated particles, to form toner particles having a core-shell structure.

After completion of the coagulation coalescence step, a well-known washing step, a well-known solid-liquid separation step, and a well-known drying step are performed on to the toner particles formed in the solution, so as to obtain toner particles in a dry state. With respect to the washing step, in view of chargeability, displacement washing with ion exchanged water may be sufficiently performed. As the solid-liquid separation step, suction filtration, pressure filtration, and the like may be performed, in view of productivity. As the drying step, freeze-drying, air stream drying, viscous flow drying, vibrating viscous drying, and the like may be performed, in view of productivity.

Then, the toner according to this exemplary embodiment is manufactured, for example, by adding an external additive to the obtained toner particles in a dry state and performing mixing. The mixing may be performed, for example, a V blender, a HENSCHEL MIXER, or a LOEDIGE MIXER. If necessary, coarse particles of the toner may be removed by using a vibration sieving machine, an air sieve separator, or the like.

Dielectric Constant of Toner

In the toner according to this exemplary embodiment, the dielectric constant is preferably 0.003 or more and 0.01 or less, for example.

In a case where the toner external additive including the specific strontium titanate particle is used, the dielectric constant is achieved.

Here, the method of measuring the dielectric constant of the toner is as below.

That is, the measurement sample is pressure-molded at 98,067 KPa (1,000 Kgf/cm²) for one minute so as to have a disc shape having a diameter of 50 mm and a thickness of 3 mm. After the measurement sample is stood for 24 hours in an atmosphere at 22° C. and a relative humidity of 55%, the dielectric constant is measured. For the measurement, a sample pressure-molded into a solid electrode having an electrode diameter of 38 mm (manufactured by Ando Electric Co., Ltd., model SE-71) is set, and a dielectric measurement system (126096 W type manufactured by Solartron Corporation) under applied voltage conditions of 1 kHz and 5 V.

Specific Strontium Titanate Particle Externally Added to Toner Particle

The toner according to this exemplary embodiment is a toner obtained by externally adding the external additive including the specific strontium titanate particle to the toner particle.

With respect to the toner according to this exemplary embodiment, in view of effectively suppressing the fogging generated during continuous printing, in a case of measuring the average primary particle diameter and the specific volume resistivity R1 of the specific strontium titanate particle externally added to the toner particle (adhered to the toner particle surface), the value thereof is also in preferably the range (10 nm or more and 100 nm or less as the average primary particle diameter and 11 or more and 14 or less in terms of the common logarithm value log R1 of the specific volume resistivity R1), for example.

The average primary particle diameter of the specific strontium titanate particle externally added to the toner particle is obtained by observing each toner particle with a scanning electron microscope (SEM) at a magnification of 40,000 times, and the specific measuring method thereof is the same as the method of measuring the average primary particle diameter of the specific strontium titanate particle.

Here, in a case where the particle other than the specific strontium titanate particle is externally added to the toner particle, the presence of Ti and Sr is checked by EDX analysis by using a scanning electron microscope (SEM) equipped with an energy dispersive X-ray analyzer (EDX apparatus) (EMAX Evolution X-Max 80 mm², manufactured by Horiba Ltd.), so as to specify the primary particle of the specific strontium titanate. The conditions of the EDX analysis are acceleration voltage of 15 kV, the emission current of 20 μA, WD of 15 mm, and the detection time of 60 minutes.

In a case of measuring the specific volume resistivity R1 of the specific strontium titanate particle externally added to the toner particle, the specific strontium titanate particle is separated from the toner particle, and the specific volume resistivity R1 of the separated strontium titanate particle may be measured by the method.

The method of separating the specific strontium titanate particle from the toner particle is a method of sufficiently dispersing the toner in a 0.2% triton solution (polyoxyethylene octylphenyl ether having a polymerization degree of 10, manufactured by Wako Pure Chemical Industries, Ltd.), operating an ultrasonic vibrator (ultrasonic homogenizer US300T, manufactured by Nippon Seiki Co., Ltd.) immersed in an ultrasonic vibrator having an oscillation frequency of 20 kHz at an output of 150 mA for 30 minutes, and detaching and collecting the specific strontium titanate particles.

Electrostatic Charge Image Developer

The electrostatic charge image developer according to this exemplary embodiment at least includes the toner according to this exemplary embodiment. The electrostatic charge image developer according to this exemplary embodiment may be a single component developer including only the toner according to this exemplary embodiment and may be a double component developer obtained by mixing the toner and a carrier.

The carrier is not particularly limited, and examples thereof include well-known carriers. Examples of the carrier include a coated carrier in which the surface of a core formed of magnetic powder is coated with a resin; a magnetic powder dispersed carrier formulated by dispersing in which magnetic powder in a matrix resin; and a resin impregnated carrier in which porous magnetic powder is impregnated with a resin. The magnetic powder dispersion type carrier and the resin impregnated carrier may be a carrier in which constituent particles of the carrier are used as a core, and the surface is coated with a resin.

Examples of the magnetic powder include magnetic metal such as iron, nickel, and cobalt; and magnetic oxides such as ferrite and magnetite.

Examples of the resin for coating and the matrix resin include polyethylene, polypropylene, polystyrene, polyvinyl acetate, polyvinyl alcohol, polyvinyl butyral, PVC, polyvinyl ether, polyvinyl ketone, a vinyl chloride-vinyl acetate copolymer, a styrene-acrylic acid ester copolymer, a straight silicone resin including an organosiloxane bond, or modified products thereof, a fluorine resin, polyester, polycarbonate, a phenol resin, and an epoxy resin. Additives such as conductive particles may be included in the coating resin and the matrix resin. Examples of the conductive particles include particles of metal such as gold, silver, and copper, carbon black, titanium oxide, zinc oxide, tin oxide, barium sulfate, aluminum borate, and potassium titanate.

In order to coat the surface of the core with the resin, a method of applying the coating resin and a coating layer forming solution obtained by dissolving various additives (used, if necessary) in an appropriate solvent, and the like may be exemplified. The solvent is not particularly limited and may be selected considering the kind of resin to be used, coating suitability, and the like. Specific examples of the resin coating method include an immersion method of immersing the core in a coating layer forming solution; a spraying method of spraying a coating layer forming solution to the surface of the core material; a viscous flow bed method of spraying the coating layer forming solution in a state in which the core is suspended by viscous flow air; and a kneader coater method of mixing a core of a carrier and a coating layer forming solution in a kneader coater and then removing the solvent.

The mixing ratio (mass ratio) of the toner and the carrier in the double-component developer is preferably from toner:carrier=1:100 to 30:100 and more preferably from 3:100 to 20:100, for example.

Image Forming Device and Image Forming Method

The image forming device and the image forming method according to this exemplary embodiment are described.

The image forming device according to this exemplary embodiment includes an image holding member, a charging unit that charges a surface of the image holding member, an electrostatic charge image forming unit that forms an electrostatic charge image on the charged surface of the image holding member, a developing unit that accommodates an electrostatic charge image developer and developing an electrostatic charge image formed on the surface of the image holding member by the electrostatic charge image developer as a toner image, a transfer unit that transfers a toner image formed on the surface of the image holding member to a surface of a recording medium, and a fixing unit that fixes the toner image transferred to the surface of the recording medium. As the electrostatic charge image developer, an electrostatic charge image developer according to this exemplary embodiment is applied.

The image forming device according to this exemplary embodiment performs an image forming method (an image forming method according to this exemplary embodiment) including a charging step of charging a surface of the image holding member, an electrostatic charge image forming step of forming an electrostatic charge image on the charged surface of the image holding member, a developing step of developing an electrostatic charge image formed on the surface of the image holding member by the electrostatic charge image developer according to this exemplary embodiment as a toner image, a transfer step of transferring a toner image formed on the surface of the image holding member to a surface of a recording medium, and a fixing unit of fixing the toner image transferred to the surface of the recording medium.

With respect to the image forming device according to this exemplary embodiment, well-known image forming devices such as a device in a direct transfer method of directly transferring a toner image formed on a surface of an image holding member to a recording medium; a device in an intermediate transfer method of firstly transferring a toner image formed on a surface of an image holding member to a surface of an intermediate transfer member and secondarily transferring the toner image transferred to the surface of the intermediate transfer member to the surface of the recording medium; a device of including a cleaning unit that cleans the surface of the image holding member after transferring of the toner image and before charging; and a device of including a discharging unit that performs discharging by irradiating the surface of the image holding member with discharging light after the transferring of the toner image and before charging.

In a case where the image forming device according to this exemplary embodiment is a device in the intermediate transferring method, a configuration in which the transfer unit, for example, includes an intermediate transfer member in which a toner image is transferred to a surface, a primary transfer unit that firstly transfers the toner image formed on the surface of the image holding member to a surface of the intermediate transfer member, and a secondary transfer unit that secondarily transfers the toner image transferred to the surface of the intermediate transfer member to a surface of a recording medium is applied.

In the image forming device according to this exemplary embodiment, for example, a portion including a developing unit may be a cartridge structure (process cartridge) that is detachably attached to the image forming device. As the process cartridge, for example, a process cartridge including a developing unit that accommodates an electrostatic charge image developer according to this exemplary embodiment is appropriately used.

Hereinafter, an example of the image forming device according to this exemplary embodiment is described, but this exemplary embodiment is not limited thereto. In the description below, major portions illustrated in the drawings are described, and explanation of the others is omitted.

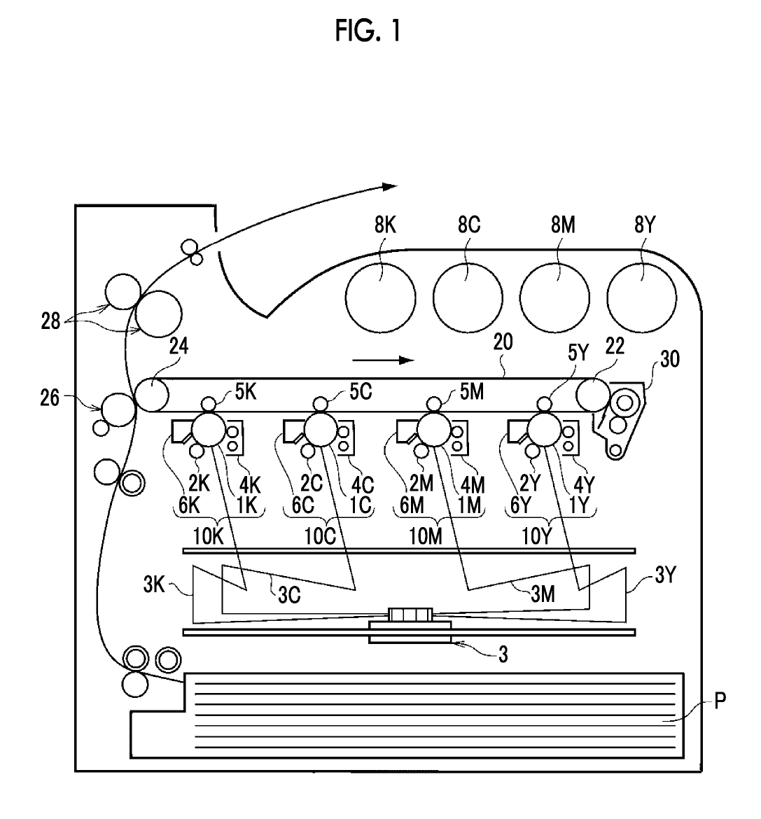

FIG. 1 is a schematic view illustrating a configuration of an image forming device of this exemplary embodiment.

The image forming device illustrated in FIG. 1 includes first to fourth image forming units 10Y, 10M, 10C, and 10K (image forming units) of an electrophotographic method that output images of respective colors of yellow (Y), magenta (M), cyan (C), and black (K) based on color separated image data. These image forming units (hereinafter, simply referred to as “units”) 10Y, 10M, 10C, and 10K are arranged to be parallel by being spaced in a predetermined distance from each other in a horizontal direction. These units 10Y, 10M, 10C, and 10K may be process cartridges that are detachably attached to the image forming device.

An intermediate transfer belt (an example of the intermediate transfer member) 20 is elongated on upper sides of the respective units 10Y, 10M, 10C, and 10K through the respective units. The intermediate transfer belt 20 is installed to wind a drive roller 22 and a support roller 24 that are in contact with an inner surface of the intermediate transfer belt 20 and is caused to drive in a direction from the first unit 10Y toward the fourth unit 10K. The force is applied to the support roller 24 in a direction of departing from the drive roller 22 by a spring or the like, such that tension is applied to the intermediate transfer belt 20. An intermediate transfer belt cleaning device 30 is provided on the image holding surface side of the intermediate transfer belt 20 to face the drive roller 22.

Respective toners of yellow, magenta, cyan, and black that are held in containers included in toner cartridges 8Y, 8M, 8C, and 8K are supplied to respective developing devices (an example of developing units) 4Y, 4M, 4C, and 4K of the respective units 10Y, 10M, 10C, and 10K.

The first to fourth units 10Y, 10M, 10C, and 10K have identical configurations and operations, and thus the first unit 10Y that is installed on an upstream side in the intermediate transfer belt driving direction and forms a yellow image is representatively described.

The first unit 10Y has a photoconductor 1Y that functions as an image holding member. Around the photoconductor 1Y, a charging roller (an example of the charging unit) 2Y that charges a surface of the photoconductor 1Y in a predetermined potential, an exposing device (an example of the electrostatic charge image forming unit) 3 that exposes the charged surface with laser beams 3Y based on a color separated image signal and forms an electrostatic charge image, a developing device (an example of the developing unit) 4Y that supplies a toner charged on an electrostatic charge image and develops an electrostatic charge image, a primary transfer roller (an example of the primary transfer unit) 5Y that transfers the developed toner image on the intermediate transfer belt 20, and a photoconductor cleaning device (an example of the image holding member cleaning unit) 6Y that removes the toner remaining on the surface of the photoconductor 1Y after primary transferring.

The primary transfer roller 5Y is disposed inside the intermediate transfer belt 20 and is provided at a position facing the photoconductor 1Y. Respective bias power supplies (not illustrated) that apply primary transfer bias are connected to the primary transfer rollers 5Y, 5M, 5C, and 5K of the respective units. The respective bias power supplies change the values of the transfer bias applied to the respective primary transfer rollers according to the control of a controller (not illustrated).

Hereinafter, movements for forming a yellow image in the first unit 10Y are described.

First, prior to the movements, the surface of the photoconductor 1Y is charged by the charging roller 2Y to a potential of −600 V to −800 V.

The photoconductor 1Y is formed by laminating a photosensitive layer on a substrate having conductivity (for example, volume resistivity at 20° C. of 1×10⁻⁶ Ωcm or less). This photosensitive layer is generally high resistance (resistance of general resin), but has properties in which the specific resistance of the portion irradiated with the laser beams changes in a case where the photosensitive layer is irradiated with laser beams. Therefore, the charged surface of the photoconductor 1Y according to image data for yellow sent from the controller (not illustrated) is irradiated with the laser beams 3Y from the exposing device 3. Accordingly, an electrostatic charge image of a yellow image pattern is formed on the surface of the photoconductor 1Y.

The electrostatic charge image is an image formed on the surface of the photoconductor 1Y by charging and is a so-called negative latent image in which the specific resistance of the irradiated portion of the photosensitive layer decreases by the laser beams 3Y such that the charged electric charged on the surface of the photoconductor 1Y flows and charges of the portion not irradiated with the laser beam 3Y are retained.

The electrostatic charge image formed on the photoconductor 1Y rotates to a predetermined developing position according to the driving of the photoconductor 1Y. In this developing position, an electrostatic charge image on the photoconductor 1Y is developed as a toner image and visualized by a developing device 4Y.

An electrostatic charge image developer including at least a yellow toner and a carrier is accommodated in the developing device 4Y. The yellow toner is frictionally electrified by being stirred inside the developing device 4Y, and has charges having the polarity the same (negative polarity) as that of the charges charged on the photoconductor 1Y and is held on a roller (an example of developer holding member). As the surface of the photoconductor 1Y passes through the developing device 4Y, the yellow toner electrostatically adheres to the latent image portion discharged on the surface of the photoconductor 1Y, and the latent image is developed with the yellow toner. The photoconductor 1Y on which the yellow toner image is formed is subsequently moved at a predetermined speed, and the toner image developed on the photoconductor 1Y is transported to a predetermined primary transfer position.

In a case where the yellow toner image on the photoconductor 1Y is transported to the primary transfer position, a primary transfer bias is applied to the primary transfer roller 5Y, the electrostatic force directed from the photoconductor 1Y toward the primary transfer roller 5Y acts on the toner image, and the toner image on the photoconductor 1Y is transferred to the intermediate transfer belt 20. The transfer bias applied at this point has a polarity (+) opposite to the polarity (−) of the toner and is controlled to +10 μA, for example, by the controller (not illustrated) in the first unit 10Y. The toner retained on the photoconductor 1Y is removed by the photoconductor cleaning device 6Y and collected.

The primary transfer bias applied to the primary transfer rollers 5M, 5C, and 5K after the second unit 10M is also controlled in accordance with the first unit.

In this manner, the intermediate transfer belt 20 to which the yellow toner image has been transferred in the first unit 10Y is transported sequentially through the second to fourth units 10M, 10C, and 10K, toner images of respective colors are superimposed and transferred in a multiplex manner.

The intermediate transfer belt 20 on which the four color toner images are transferred in a multiplex manner through the first to fourth units reaches a secondary transfer portion including an intermediate transfer belt 20, the support roller 24 in contact with the inner surface of the intermediate transfer belt, and a secondary transfer roller (an example of the secondary transfer unit) 26 disposed on the image holding surface side of the intermediate transfer belt 20. On the other hand, recording paper (an example of a recording medium) P is fed to the gap between the secondary transfer roller 26 and the intermediate transfer belt 20 via a supply mechanism at a predetermined timing, and the secondary transfer bias is applied to the support roller 24. The transfer bias applied at this point has a polarity (−) of polarity the same as the polarity (−) of the toner, and the electrostatic force directed from the intermediate transfer belt 20 toward the recording paper P acts on the toner image, and the toner image on the intermediate transfer belt 20 is transferred onto the recording paper P. The secondary transfer bias at this point is determined according to the resistance detected by a resistance detection unit (not illustrated) for detecting the resistance of the secondary transfer portion, and the voltage is controlled.

The recording paper P to which the toner image is transferred is sent to a pressure contact portion (nip portion) of a pair of fixing rollers in a fixing device (an example of the fixing unit) 28, a toner image is fixed on the recording paper P, and a fixed image is formed. The recording paper P on which fixing of the color image is completed is exported toward the discharging section, and the series of color image forming movements is ended.

Examples of the recording paper P to which the toner image is transferred include plain paper used for a copying machine or a printer in the electrophotographic method. Examples of the recording medium include an OHP sheet in addition to the recording paper P. In order to further improve the smoothness of the image surface after fixing, it is preferable that the surface of the recording paper P is also smooth, for example. For example, coated paper obtained by coating the surface of plain paper with a resin or the like, art paper for printing, and the like are appropriately used.

Process Cartridge and Toner Cartridge

The process cartridge according to this exemplary embodiment is a process cartridge that includes a developing unit accommodating the electrostatic charge image developer according to this exemplary embodiment, developing an electrostatic charge image formed on the surface of the image holding member by the electrostatic charge image developer as the toner image and that is detachably attached to the image forming device.

The process cartridge according to this exemplary embodiment may have a configuration of including a developing unit and, for example, at least one selected from other units such as an image holding member, a charging unit, an electrostatic charge image forming unit, and a transfer unit, if necessary.

Hereinafter, an example of the process cartridge according to this exemplary embodiment is described, but the present invention is not limited thereto. In the description below, major portions illustrated in the drawings are described, and explanation of the others is omitted.

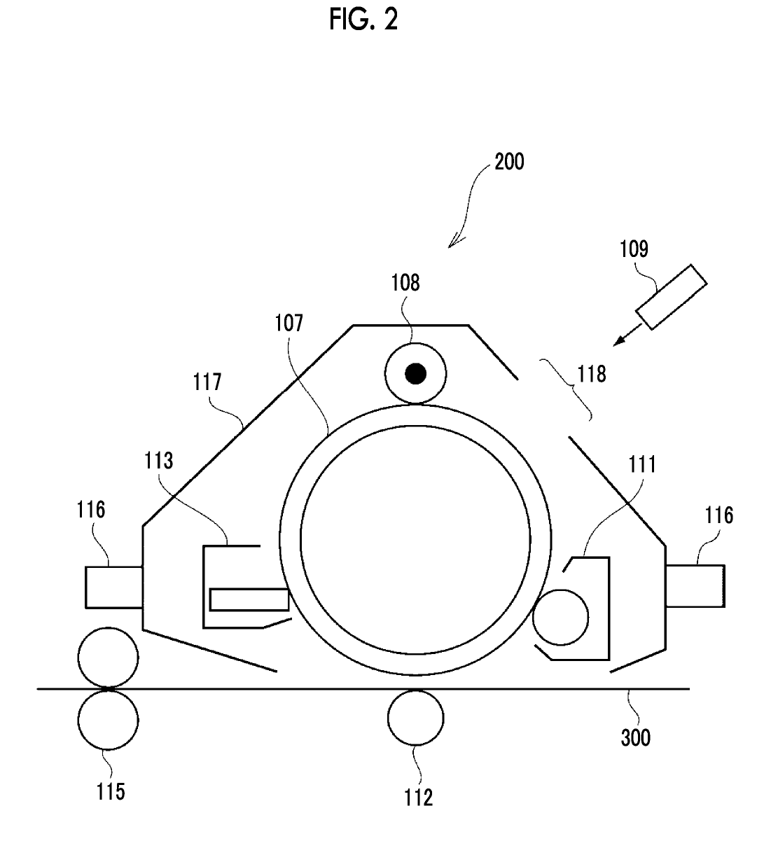

FIG. 2 is a schematic view illustrating the process cartridge according to this exemplary embodiment.

A process cartridge 200 illustrated in FIG. 2 becomes a cartridge combining and holding a photoconductor 107 (an example of the image holding member), a charging roller 108 (an example of the charging unit) around the photoconductor 107, a developing device 111 (an example of the developing unit), and a photoconductor cleaning device 113 (an example of the cleaning unit) in an integrated manner, for example, by a housing 117 including a mounting rail 116 and an opening 118 for exposure.

In FIG. 2, 109 indicates an exposing device (an example of the electrostatic charge image forming unit), 112 indicates a transfer device (an example of the transfer unit), 115 indicates a fixing device (an example of the fixing unit), and 300 indicates a recording paper (an example of the recording medium).

Subsequently, the toner cartridge according to this exemplary embodiment is described.

The toner cartridge according to this exemplary embodiment is a toner cartridge that includes a container that accommodates the toner according to this exemplary embodiment and is detachably attached to the image forming device. The toner cartridge includes the container that accommodates the replenishing toner for being supplied to the developing unit provided in the image forming device.

The image forming device illustrated in FIG. 1 is an image forming device having a configuration in which the toner cartridges 8Y, 8M, 8C, and 8K are detachably attached, and the developing devices 4Y, 4M, 4C, and 4K are connected to the toner cartridges corresponding to the respective colors by toner supply tubes (not illustrated). In a case where the toner that is accommodated in the container of the toner cartridge becomes less, this toner cartridge is replaced.

### EXAMPLES

Hereinafter, the exemplary embodiment of the present invention is specifically described with reference to examples, but the present invention is not limited to these examples. Herein, unless otherwise specified, “part” and “%” are based on mass.

Manufacturing of Strontium Titanate Particle

Strontium Titanate Particle (1)

0.7 mol of metatitanic acid which is a desulfurized and deflocculated titanium source as TiO₂ is sampled and put into a reaction container. Subsequently, 0.77 mol of an aqueous strontium chloride solution is added to the reaction container such that the SrO/TiO₂ molar ratio becomes 1.1. Subsequently, a solution obtained by dissolving lanthanum oxide in nitric acid is added to the reaction container in an amount in which lanthanum becomes 5 moles with respect to 100 moles of strontium. The initial concentration of TiO₂ in the mixed solution of the three materials is caused to be 0.75 mol/L.

Subsequently, the mixed solution is stirred, the mixed solution is heated to 90° C., the temperature of the liquid is maintained at 90° C., 153 mL of a 10 N aqueous solution of sodium hydroxide is added over 3.8 hours under stirring, and stirring is continuously performed over one hour while the temperature of the liquid is maintained at 90° C. Subsequently, the reaction solution is cooled to 40° C., hydrochloric acid is added until pH becomes 5.5, and stirring is performed over one hour. Subsequently, the precipitate is washed by repeating decantation and dispersion in water. Hydrochloric acid is added to the slurry containing the washed precipitate, pH is adjusted to 6.5, and solid-liquid separation is performed by filtration.

Subsequently, an ethanol solution of i-butyltrimethoxysilane is added to the obtained solid content (untreated strontium titanate particles) in an amount such that i-butyltrimethoxysilane becomes 15 parts with respect to 100 parts of the solid content, and stirring is performed over one hour.

The solid-liquid separation is performed by filtration, and the solid content is dried over five hours in the atmosphere of 110° C., so as to obtain a strontium titanate particle (1).

Strontium Titanate Particle (2)

A strontium titanate particle (2) is manufactured in the same manner as the manufacturing of the strontium titanate particle (1), except for adding a solution obtained by dissolving lanthanum oxide in nitric acid in an amount such that lanthanum becomes 10 parts with respect to 100 parts of strontium and changing the addition amount of an ethanol solution of i-butyltrimethoxysilane in an amount such that i-butyltrimethoxysilane becomes 10 parts with respect to 100 parts of the solid content.

Strontium Titanate Particle (3)

A strontium titanate particle (3) is manufactured in the same manner as the manufacturing of the strontium titanate particle (1), except for adding a solution obtained by dissolving lanthanum oxide in nitric acid in an amount such that lanthanum becomes 2.5 moles with respect to 100 moles of strontium and changing the addition amount of an ethanol solution of i-butyltrimethoxysilane in an amount such that i-butyltrimethoxysilane becomes 20 parts with respect to 100 parts of the solid content.

Strontium Titanate Particle (4)

A strontium titanate particle (4) is manufactured in the same manner as the manufacturing of the strontium titanate particle (1), except for performing the solid-liquid separation by filtration and drying the solid content over eight hours in the atmosphere of 110° C.

Strontium Titanate Particle (5)

A strontium titanate particle (5) is manufactured in the same manner as the manufacturing of the strontium titanate particle (1), except for adding a solution obtained by dissolving lanthanum oxide in nitric acid in an amount such that lanthanum becomes 7.5 moles with respect to 100 moles of strontium, changing the addition amount of an ethanol solution of i-butyltrimethoxysilane in an amount such that i-butyltrimethoxysilane becomes 25 parts with respect to 100 parts of the solid content, performing the solid-liquid separation by filtration, and drying the solid content over three hours in the atmosphere of 110° C.

Strontium Titanate Particle (6)

A strontium titanate particle (6) is manufactured in the same manner as the manufacturing of the strontium titanate particle (5), except for adding a solution obtained by dissolving lanthanum oxide in nitric acid in an amount such that lanthanum becomes 2.5 moles with respect to 100 moles of strontium and changing the addition amount of an ethanol solution of i-butyltrimethoxysilane in an amount such that i-butyltrimethoxysilane becomes 20 parts with respect to 100 parts of the solid content.

Strontium Titanate Particle (7)

A strontium titanate particle (7) is manufactured in the same manner as the manufacturing of the strontium titanate particle (6), except for drying the solid content over 10 hours in the atmosphere of 110° C.

Strontium Titanate Particle (8)

A strontium titanate particle (8) is manufactured in the same manner as the manufacturing of the strontium titanate particle (6), except for changing the addition amount of an ethanol solution of i-butyltrimethoxysilane in an amount such that i-butyltrimethoxysilane becomes 20 parts with respect to 100 parts of the solid content.

Strontium Titanate Particle (9)

A strontium titanate particle (9) is manufactured in the same manner as the manufacturing of the strontium titanate particle (5), except for changing the addition amount of an ethanol solution of i-butyltrimethoxysilane in an amount such that i-butyltrimethoxysilane becomes 23 parts with respect to 100 parts of the solid content.

Strontium Titanate Particle (10)

A strontium titanate particle (10) is manufactured in the same manner as the manufacturing of the strontium titanate particle (4), except for adding a solution obtained by dissolving lanthanum oxide in nitric acid in an amount such that lanthanum becomes 10 moles with respect to 100 moles of strontium and changing the addition amount of an ethanol solution of i-butyltrimethoxysilane in an amount such that i-butyltrimethoxysilane becomes 15 parts with respect to 100 parts of the solid content.

Strontium Titanate Particle (11)

A strontium titanate particle (11) is manufactured in the same manner as the manufacturing of the strontium titanate particle (10), except for adding a solution obtained by dissolving lanthanum oxide in nitric acid in an amount such that lanthanum becomes 2.5 moles with respect to 100 moles of strontium and adding 153 mL of a 10 N aqueous solution of sodium hydroxide over 1.5 hours.

Strontium Titanate Particle (12)

A strontium titanate particle (12) is manufactured in the same manner as the manufacturing of the strontium titanate particle (10), except for adding a solution obtained by dissolving lanthanum oxide in nitric acid in an amount such that lanthanum becomes 5 moles with respect to 100 moles of strontium and adding 153 mL of a 10 N aqueous solution of sodium hydroxide over 10 hours.

Strontium Titanate Particle (13)

A strontium titanate particle (13) is manufactured in the same manner as the manufacturing of the strontium titanate particle (1), except for changing the addition amount of an ethanol solution of i-butyltrimethoxysilane in an amount such that i-butyltrimethoxysilane becomes 3 parts with respect to 100 parts of the solid content.

Strontium Titanate Particle (14)

A strontium titanate particle (14) is manufactured in the same manner as the manufacturing of the strontium titanate particle (1), except for adding a solution obtained by dissolving lanthanum oxide in nitric acid in an amount such that lanthanum becomes 0.5 moles with respect to 100 moles of strontium, changing the addition amount of an ethanol solution of i-butyltrimethoxysilane in an amount such that i-butyltrimethoxysilane becomes 10 parts with respect to 100 parts of the solid content, performing the solid-liquid separation by filtration, and drying the solid content over 12 hours in the atmosphere of 110° C.

Strontium Titanate Particle (15)

A strontium titanate particle (15) is manufactured in the same manner as the manufacturing of the strontium titanate particle (1), except for adding a solution obtained by dissolving lanthanum oxide in nitric acid in an amount such that lanthanum becomes 12 moles with respect to 100 moles of strontium, changing the addition amount of an ethanol solution of i-butyltrimethoxysilane in an amount such that i-butyltrimethoxysilane becomes 30 parts with respect to 100 parts of the solid content, performing the solid-liquid separation by filtration, and drying the solid content over two hours in the atmosphere of 110° C.

Strontium Titanate Particle (16)

A strontium titanate particle (16) is manufactured in the same manner as the manufacturing of the strontium titanate particle (1), except for except for not adding a solution obtained by dissolving lanthanum oxide in nitric acid, not performing a hydrophobic treatment by an ethanol solution of i-butyltrimethoxysilane, and performing the solid-liquid separation by filtration and drying the solid content over 12 hours in the atmosphere of 120° C.

Strontium Titanate Particle (17)

A strontium titanate particle (17) is manufactured in the same manner as the manufacturing of the strontium titanate particle (2), except for not adding a solution obtained by dissolving lanthanum oxide in nitric acid.

Strontium Titanate Particle (18)

A strontium titanate particle (18) is manufactured in the same manner as the manufacturing of the strontium titanate particle (1), except for adding a solution obtained by dissolving lanthanum oxide in nitric acid in an amount such that lanthanum becomes 10 moles with respect to 100 moles of strontium, adding 153 mL of a 10 N aqueous solution of sodium hydroxide over 16 hours, and changing the addition amount of an ethanol solution of i-butyltrimethoxysilane in an amount such that i-butyltrimethoxysilane becomes 8 parts with respect to 100 parts of the solid content.

Strontium Titanate Particle (19)

A strontium titanate particle (19) is manufactured in the same manner as the manufacturing of the strontium titanate particle (1), except for adding a solution obtained by dissolving lanthanum oxide in nitric acid in an amount such that lanthanum becomes 1 part with respect to 100 parts of strontium, performing the solid-liquid separation by filtration, and drying the solid content over 10 hours in the atmosphere of 110° C.

Various Measurements

With respect to the strontium titanate particle, an average primary particle diameter, the specific volume resistivity R1, the resistance component R by the impedance method, the capacitance component C, the moisture content, and the mass ratio (Si/Sr) of silicon (Si) and strontium (Sr) calculated from quantitative and qualitative analyses of the fluorescence X-ray analysis are measured.

With respect to the untreated strontium titanate particle obtained in the course of manufacturing the strontium titanate particle, the specific volume resistivity R2 is measured, and log R1−log R2 is also calculated.

These measurements are performed in the measuring methods.

Results of the various measurements are provided in Table 1.

Manufacturing of Toner Particle

Toner Particle (1)

Preparation of Resin Particle Dispersion (1)
Terephthalic acid: 30 parts by mole
Fumaric acid: 70 parts by mole
Bisphenol A ethylene oxide adduct: 5 parts by mole
Bisphenol A propylene oxide adduct: 95 parts by mole

The above materials are introduced to a flask equipped with a stirrer, a nitrogen introduction pipe, a temperature sensor, and a rectification column, the temperature is raised to 220° C. over one hour, and 1 part of titanium tetraethoxide is added to 100 parts of the material is introduced. While generated water is distilled off, the temperature is raised to 230° C. over 30 minutes, the dehydration condensation reaction is continued for one hour at the temperature, and the reaction product is cooled. In this manner, a polyester resin having a weight-average molecular weight of 18,000 and a glass transition temperature of 60° C. is obtained.

40 parts of ethyl acetate and 25 parts of 2-butanol are introduced into a container equipped with a temperature regulating unit and a nitrogen replacing unit to obtain a mixed solvent, 100 parts of a polyester resin is gradually added and dissolved, and 10 mass % of an aqueous ammonia solution (equivalent to 3 times by the molar ratio with respect to the acid value of the resin) are put, and stirring is performed over 30 minutes. Subsequently, the inside of the container is replaced with dry nitrogen, the temperature is maintained at 40° C., and 400 parts of ion exchanged water is added dropwise at a rate of 2 parts/min while the mixed solution is stirred. After the dropwise addition is completed, the temperature is returned to room temperature (20° C. to 25° C.), and bubbling is performed for 48 hours with dry nitrogen under stirring to obtain a resin particle dispersion in which ethyl acetate and 2-butanol are reduced to 1,000 ppm or less. Ion exchanged water is added to the resin particle dispersion, and the solid content is adjusted to 20 mass % so as to obtain a resin particle dispersion (1).

Preparation of Colorant Particle Dispersion (1)
Regal 330 (Carbon black manufactured by Cabot Corporation): 70 parts
Anionic surfactant (NEOGEN RK, manufactured by Dai-ichi Kogyo Seiyaku Co., Ltd.): 5 parts
Ion exchanged water: 200 parts

The materials are mixed and dispersed for 10 minutes by using a homogenizer (trade name ULTRA-TURRAX T50 manufactured by IKA-Werke GmbH & Co. KG). Ion exchanged water is added such that the solid content in the dispersion became 20 mass % so as to obtain a colorant particle dispersion (1) in which colorant particles having a volume average particle diameter of 170 nm are dispersed.

Preparation of Releasing Agent Particle Dispersion (1)
Paraffin wax (Nippon Seiro Co., Ltd., HNP-9): 100 parts
Anionic surfactant (NEOGEN RK, manufactured by Dai-ichi Kogyo Seiyaku Co., Ltd.): 1 part
Ion exchanged water: 350 parts

The materials are mixed, heated to 100° C., dispersed using a homogenizer (IKA-Werke GmbH & Co. KG, trade name ULTRA-TURRAX T50), and performing a distribution treatment a MANTON GAULIN high pressure homogenizer (Gaulin Co., Ltd.), to obtain a releasing agent particle dispersion (1) (solid content amount: 20 mass %) in which the releasing agent particle having a volume average particle diameter of 200 nm is dispersed.

Manufacturing of Toner Particle (1)
Resin particle dispersion (1): 403 parts
Colorant particle dispersion (1): 12 parts
Releasing agent particle dispersion (1): 50 parts
Anionic surfactant (TaycaPower): 2 parts

The materials are introduced in a round stainless steel flask, 0.1 N nitric acid is added such that pH is adjusted to 3.5, and 30 parts of an aqueous nitric acid solution having a polyaluminum chloride concentration of 10 mass % is added. Subsequently, the mixture is dispersed at a liquid temperature of 30° C. using a homogenizer (IKA-Werke GmbH & Co. KG, trade name ULTRA TURRAX T50), heated to 45° C. in a heating oil bath, and maintained for 30 minutes.

Thereafter, 100 parts of the resin particle dispersion (1) is gradually added and is maintained for one hour, a 0.1 N aqueous solution of sodium hydroxide solution is added such that pH is adjusted to 8.5, heating is performed to 84° C. while stirring is continued, and the mixture is maintained for 2.5 hours. Thereafter, the mixture is cooled to 20° C. at a rate of 20° C./min, filtered, sufficiently washed with ion exchanged water, and dried so as to obtain a toner particle (1) having a volume average particle diameter of 5.8 μm.

Manufacturing of Carrier

A carrier is used one manufactured as follows.
Ferrite particle (volume average particle diameter: 36 μm): 100 parts
Toluene: 14 parts
Styrene-methyl methacrylate copolymer: 2 parts (Component ratio: 90/10, Mw=80,000)
Carbon black (R330: manufactured by Cabot Corporation): 0.2 parts

First, the components other than ferrite particles are stirred for 10 minutes with a stirrer so as to prepare a dispersed coating liquid, this coating liquid and ferrite particles are introduced to in a vacuum degassing type kneader, and stirred for 30 minutes at 60° C., further desired by reducing the pressure while heating, and dried so as to obtain the carrier.

### Manufacturing of Toner and Developer: Example 1

0.95 parts of a strontium titanate particle (1) as an external additive is added to 100 parts of the toner particle (1), stirred by a HENSCHEL MIXER, at a stirring circumferential speed of 30 m/sec for 15 minutes, so as to obtain a toner.

Each obtained toner and a carrier are placed in a V blender at a ratio of toner:carrier=8:92 (mass ratio) and stirred for 20 minutes so as to obtain a developer.

### Manufacturing of Toner and Developer: Examples 2 to 15 and Comparative Examples 1 to 4

Toners and developers are manufactured in the same manner as in Example 1 except for changing the strontium titanate particle (1) to strontium titanate particles presented in Table 1.

Evaluation

The obtained developers of each example are accommodated in a developing device of a modified machine of an image forming device “ApeosPort-IV C5575 (manufactured by Fuji Xerox Co., Ltd.)” (a modified machine with a concentration automatic control sensor disconnected in environmental fluctuation).

30,000 images of 1% image density are continuously printed to A4 paper is performed in each of the high temperature and high humidity environment (under the environment of 28° C./85% RH) and the low temperature and low humidity environment (under the environment of 10° C./15% RH), by using the remodeled machine of this image forming device, and the last 30 sheets are visually observed, so as to perform fogging evaluation. The evaluation results are provided in Table 1.

The evaluation standard was as below.

G1: Fogging is not recognized in all of the 30 sheets.

G2: Fogging is slightly recognized in one sheet, but in an acceptable range in practice.

G3: Fogging is slightly recognized in two sheets, but in an acceptable range in practice.

G4: Fogging is slightly recognized in plural sheets, but in an acceptable range in practice.

G5: Fogging is clearly recognized in plural sheets and is not suitable in practice.

G6: Fogging is entirely recognized in plural sheets.

TABLE 1

| | Strontium Titanate Particle | | | | | | | | |
|---|---|---|---|---|---|---|---|---|---|
| | | Physical Measurement Value | | | | | | | |
| | | | | | Log | | | | |
| | | Particle | | | R1- | Resistance | Capacitance | Moisture | Molar |
| | | Diameter | Log | Log | Log | Component | Component | Content | Ratio |
| | No. | [nm] | R1 | R2 | R2 | R | C | [%] | (Si/Sr) |
| Example 1 | (1) | 50 | 12.5 | 8 | 4.5 | 9.0 | −10.0 | 3.2 | 0.09 |
| Example 2 | (2) | 50 | 11 | 8 | 3.0 | 8.5 | −9.3 | 3.1 | 0.05 |
| Example 3 | (3) | 50 | 14 | 8 | 6.0 | 10.0 | −11.0 | 2.9 | 0.11 |
| Example 4 | (4) | 50 | 12.5 | 8 | 4.5 | 9.5 | −10.0 | 2.2 | 0.05 |
| Example 5 | (5) | 50 | 12.5 | 6 | 6.5 | 9.0 | −9.7 | 5.1 | 0.16 |
| Example 6 | (6) | 50 | 12.5 | 6 | 6.5 | 9.8 | −11.0 | 4.8 | 0.05 |
| Example 7 | (7) | 50 | 12.5 | 10 | 2.5 | 10 | −10.2 | 2 | 0.05 |
| Example 8 | (8) | 50 | 12.5 | 6 | 6.5 | 9.2 | −9.8 | 5.1 | 0.11 |
| Example 9 | (9) | 50 | 11 | 6 | 5.0 | 8.3 | −9.3 | 5 | 0.13 |
| Example 10 | (10) | 50 | 13 | 10 | 3.0 | 10 | −10.9 | 2.1 | 0.09 |
| Example 11 | (11) | 30 | 12.5 | 8 | 4.5 | 9.1 | −10 | 2.7 | 0.09 |
| Example 12 | (12) | 80 | 12.5 | 8 | 4.5 | 8.9 | −9.8 | 2.7 | 0.09 |
| Example 13 | (14) | 50 | 14 | 11 | 3.0 | 10.2 | −11.2 | 1.5 | 0.05 |
| Example 14 | (15) | 50 | 12.5 | 5.5 | 7.0 | 9.7 | −10.7 | 4.8 | 0.18 |
| Example 15 | (17) | 50 | 12.5 | 10.2 | 2.3 | 9.8 | −10.7 | 2.9 | 0 |
| Comparative | (13) | 50 | 10 | 8 | 2.0 | 7.7 | −9.4 | 3.2 | 0.02 |
| Example 1 | | | | | | | | | |
| Comparative | (16) | 50 | 10.2 | 10.2 | 0 | 7.9 | −9.6 | 0.98 | 0 |
| Example 2 | | | | | | | | | |
| Comparative | (18) | 110 | 11 | 8 | 3 | 8.7 | -9.2 | 3 | 0.04 |
| Example 3 | | | | | | | | | |
| Comparative | (19) | 50 | 14.5 | 10 | 4.5 | 10.4 | −11.1 | 1.8 | 0.09 |
| Example 4 | | | | | | | | | |

| | Strontium Titanate Particle | | | | | Fogging | |
|---|---|---|---|---|---|---|---|
| | Manufacturing Condition | | | | | under Low | under High |
| | La | | | Dry | | Temperature | Temperature |
| | Added | | Treatment | Temper- | Dry | and Low | and High |
| | Amount | Hydrophobic treatment | Amount | ature | Time | Humidity | Humidity |
| | [mol] | agent | [part] | [° C.] | (hour) | Condition | Condition |
| Example 1 | 5 | i-butyltrimethoxysilane | 15 | 110 | 5 | G1 | G1 |
| Example 2 | 10 | i-butyltrimethoxysilane | 10 | 110 | 5 | G1 | G2 |
| Example 3 | 2.5 | i-butyltrimethoxysilane | 20 | 110 | 5 | G2 | G1 |
| Example 4 | 5 | i-butyltrimethoxysilane | 10 | 110 | 8 | G2 | G1 |
| Example 5 | 7.5 | i-butyltrimethoxysilane | 25 | 110 | 3 | G1 | G2 |
| Example 6 | 2.5 | i-butyltrimethoxysilane | 10 | 110 | 3 | G2 | G2 |
| Example 7 | 2.5 | i-butyltrimethoxysilane | 10 | 110 | 10 | G3 | G2 |
| Example 8 | 2.5 | i-butyltrimethoxysilane | 20 | 110 | 3 | G3 | G2 |
| Example 9 | 7.5 | i-butyltrimethoxysilane | 23 | 110 | 3 | G3 | G3 |
| Example 10 | 10 | i-butyltrimethoxysilane | 15 | 110 | 8 | G4 | G3 |
| Example 11 | 2.5 | i-butyltrimethoxysilane | 15 | 110 | 8 | G1 | G1 |
| Example 12 | 5 | i-butyltrimethoxysilane | 15 | 110 | 8 | G2 | G2 |
| Example 13 | 0.5 | i-butyltrimethoxysilane | 10 | 110 | 12 | G4 | G4 |
| Example 14 | 12 | i-butyltrimethoxysilane | 30 | 110 | 2 | G3 | G3 |
| Example 15 | 0 | i-butyltrimethoxysilane | 10 | 110 | 5 | G3 | G3 |
| Comparative | 5 | i-butyltrimethoxysilane | 3 | 110 | 5 | G5 | G5 |
| Example 1 | | | | | | | |
| Comparative | 0 | — | 0 | 120 | 12 | G6 | G6 |
| Example 2 | | | | | | | |
| Comparative | 10 | i-butyltrimethoxysilane | 8 | 110 | 5 | G5 | G5 |
| Example 3 | | | | | | | |
| Comparative | 1 | i-butyltrimethoxysilane | 15 | 110 | 10 | G6 | G6 |
| Example 4 | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A toner external additive comprising:
a strontium titanate particle which has a hydrophobized surface, in which an average primary particle diameter is 10 nm or more and 100 nm or less, and a specific volume resistivity R1 is 11 or more and 14 or less in terms of a common logarithm value log R1.

2. The toner external additive according to claim 1,
wherein a resistance component R and a capacitance component C in a case where the strontium titanate particle is measured by an impedance method satisfy Expressions a and b.
8≤common logarithm value log R of resistance component R≤10 Expression a
−11≤common logarithm value log C of capacitance component C≤−9.5 Expression b

3. The toner external additive according to claim 2,
wherein the resistance component R and the capacitance component C satisfy Expressions a1 and b1.
8.5≤common logarithm value log R of resistance component R≤9.5 Expression a1
−10.5≤common logarithm value log C of capacitance component C≤−9.5 Expression b2

4. The toner external additive according to claim 1,
wherein a specific volume resistivity R2 of the strontium titanate particle before the hydrophobized surface is formed is 6 or more and 10 or less in terms of a common logarithm value log R2.

5. The toner external additive according to claim 4,
wherein the specific volume resistivity R2 of the strontium titanate particle before the hydrophobized surface is formed is 7 or more and 9 or less in terms of the common logarithm value log R2.

6. The toner external additive according to claim 4,
wherein a difference log R1−log R2 between the common logarithm value log R1 of the specific volume resistivity R1 and the common logarithm value log R2 of the specific volume resistivity R2 is 2 or more and 7 or less.

7. The toner external additive according to claim 1,
wherein a moisture content of the strontium titanate particle is 1.5% or more and 10% or less.

8. The toner external additive according to claim 7,
wherein a moisture content of the strontium titanate particle is 2% or more and 5% or less.

9. The toner external additive according to claim 1,
wherein an average primary particle diameter of the strontium titanate particle is 20 nm or more and 80 nm or less.

10. The toner external additive according to claim 9,
wherein the average primary particle diameter of the strontium titanate particle is 20 nm or more and 60 nm or less.

11. The toner external additive according to claim 1,
wherein the specific volume resistivity R1 of the strontium titanate particle is 11 or more and 13 or less in terms of the common logarithm value log R1.

12. The toner external additive according to claim 11,
wherein the specific volume resistivity R1 of the strontium titanate particle is 12 or more and 13 or less in terms of the common logarithm value log R1.

13. The toner external additive according to claim 1,
wherein the strontium titanate particle is a strontium titanate particle doped with a metal element other than titanium and strontium.

14. The toner external additive according to claim 13,
wherein the strontium titanate particle is a strontium titanate particle doped with lanthanum.

15. The toner external additive according to claim 1,
wherein the strontium titanate particle is a strontium titanate particle having the hydrophobized surface surface-treated with a silicon-containing organic compound.

16. The toner external additive according to claim 15,
wherein the silicon-containing organic compound is at least one selected from the group consisting of an alkoxysilane compound and silicone oil.

17. The toner external additive according to claim 15,
wherein a mass ratio (Si/Sr) of silicon (Si) and strontium (Sr) calculated from quantitative and qualitative analyses of a fluorescence X-ray analysis of the strontium titanate particle is 0.025 or more and 0.25 or less.

18. An electrostatic charge image developing toner comprising:
a toner particle; and
the toner external additive according to claim 1, which is externally added to the toner particle.

19. The electrostatic charge image developing toner according to claim 18,
wherein a dielectric constant is 0.003 or more and 0.01 or less.

20. An electrostatic charge image developer comprising:
the electrostatic charge image developing toner according to claim 18.
